(19) United States
(12) Patent Application Publication
(10) Pub. No.: US 2010/0079029 A1
(43) Pub. Date: Apr. 1, 2010

(54) LAMINATED CORE ARRANGEMENT WITH A CLAW-TYPE END PLATE

(75) Inventor: Jörg Müller, Nudlingen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/569,230

(22) Filed: Sep. 29, 2009

(30) Foreign Application Priority Data
Sep. 30, 2008 (EP) EP08017239

(51) Int. Cl. H02K 1/18

(52) U.S. Cl. 310/216.114

(57) ABSTRACT

A laminated core arrangement includes a laminated core which has a multiplicity of individual laminates along a rotation axis of the electrical machine and has a plurality of cutouts which extend along the rotation axis. A claw-type end plate is arranged on one end face of the laminated core for securing the end individual laminate. The claw-type end plate has an annular inner area from which projections which are in the form of claws project outward in the form of a star, with the inner part of each of the projections pointing radially outward, and with the outer free end of each of the projections pointing into one of the cutouts in the laminated core. The claw-type end plate can be mounted together with the laminated core on a shaft in a single process step.

### CROSS-REFERENCES TO RELATED APPLICATIONS

This application claims the priority of European Patent Application, Serial No. EP 08017239, filed Sep. 30, 2008, pursuant to 35 U.S.C. 119(a)-(d), the content of which is incorporated herein by reference in its entirety as if fully set forth herein.

### BACKGROUND OF THE INVENTION

The present invention relates to a laminated core arrangement for an electrical machine having a laminated core, and to an electric motor having such a laminated core arrangement.

The following discussion of related art is provided to assist the reader in understanding the advantages of the invention, and is not to be construed as an admission that this related art is prior art to this invention.

Because of the increasing requirements for the performance of electric motors, the electrical laminates for rotors and stators must be made ever thinner. Although this reduces the motor losses, it results in considerable assembly disadvantages, however.

When manufacturing rotors, for example, the individual rotor laminates are held together with a certain amount of pressure in a laminated core, and are mounted in this way on a shaft. A rotor laminate at the end has the tendency to bend outwards as a result of the stresses. This results in uncontrolled protrusions on the rotor. Depending on the construction of the motor, this can even in some circumstances lead to the rotor laminate resting on inactive parts of the motor. Relative movement during operation therefore results in wear, which can possibly lead to failure of the motor. Furthermore, the bent rotor laminates can lead to vibration problems, which must be taken into account.

It has also been found that the thinner the laminate in a laminated core, the less is the holding force on the shaft. During the rest of the manufacturing process, this can lead to twisting, for example of the last rotor laminate.

Until now, ribbed nails and hollow rivets have been used in order to largely prevent uncontrolled bending of the outer or end rotor laminates. These are fitted to the respective rotor laminate subsequently, i.e. after the laminated core has been mounted on a shaft. Since the ribbed nails and the hollow rivets must be evenly distributed about the circumference and individually attached, rotor assembly becomes time-consuming.

It would therefore be desirable and advantageous to address prior art shortcomings and to simplify the assembly for an electrical machine and for a laminated core arrangement for an electrical machine.

### SUMMARY OF THE INVENTION

According to one aspect of the present invention, a laminated core arrangement for an electrical machine includes a laminated core having individual laminates along a rotation axis of the electrical machine and having a plurality of cutouts which extend along the rotation axis, and a claw-type end plate arranged on one end face of the laminated core and having an annular inner area provided with projections configured in the form of claws and extending outward in the form of a star, each said projection having an inner part which points radially outward, and an outer free end which points into a respective one of the cutouts in the laminated core.

The provision of a claw-type end plate according to the invention advantageously makes it possible to produce a relatively inflexible laminated core arrangement even with very thin individual laminates, which can be mounted on a shaft as an entity. This means that there is no longer any need for a large number of individual process steps in order to prevent bending of end laminates of, for example, a rotor laminated core.

According to another advantageous feature of the present invention, the claw-type end plate can be shaped to seat in the cutouts in the laminated core in an interlocking engagement and/or force-fitting manner with respect to an axial movement. As a result, the claw-type end plate supports and fixes the end laminate(s) of a laminated core.

According to another advantageous feature of the present invention, the claw-type end plate can be shaped such that it is seated in the cutouts in the laminated core in an interlocking and/or force-fitting manner with respect to a movement in the circumferential direction. In this way, twisting of an end laminate of the laminated core arrangement can be effectively prevented during assembly of the laminated core arrangement.

According to still another advantageous feature of the present invention, the free end of the projection may extend through a plurality of individual laminates in an axial direction. As a result, a plurality of laminates can be fixed to one another on the end face of a laminated core.

According to still another advantageous feature of the present invention, the laminated core arrangement may be constructed in the form of a rotor and mounted on a shaft. Such a rotor can be used for an electric motor, to reduce vibration problems and undesirable wear.

According to another advantageous feature of the present invention, the annular inner area of the claw-type end plate can be mounted on the shaft with an interference or press fit. This allows the claw-type end plate to ensure that the rotor is held better on a shaft in the axial direction and in the circumferential direction.

According to another aspect of the present invention, an electric motor includes a rotor defined by a rotation axis and having a laminated core which is comprised of individual laminates along the rotation axis and has a plurality of cutouts which extend along the rotation axis, and a claw-type end plate arranged on one end face of the laminated core and having an annular inner area provided with projections configured in the form of claws and extending outward in the form of a star, each said projection having an inner part which points radially outward, and an outer free end which points into a respective one of the cutouts in the laminated core.

According to still another aspect of the present invention, a method of making a laminated core includes the steps of stacking a plurality of laminates, thereby defining an outermost laminate, and placing a claw-type end plate onto the outermost laminate to secure the outermost laminate in place.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective illustration of a rotor of an electric motor;

FIG. 2 is a perspective illustration of a claw-type end plate according to the present invention; and

FIG. 3 is a perspective illustration of the rotor with additional attachment of a claw-type end plate.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

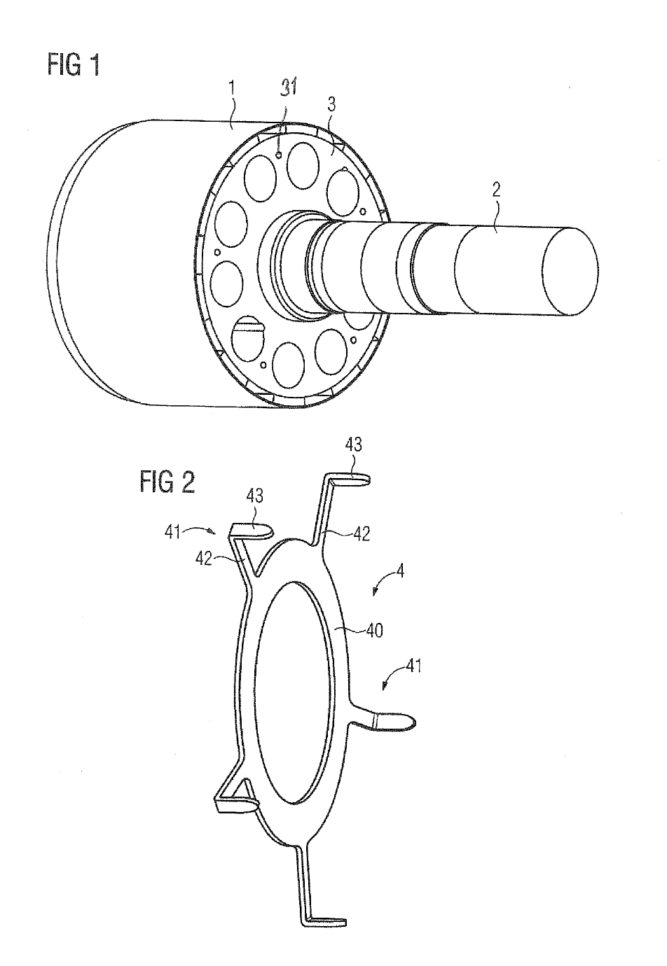

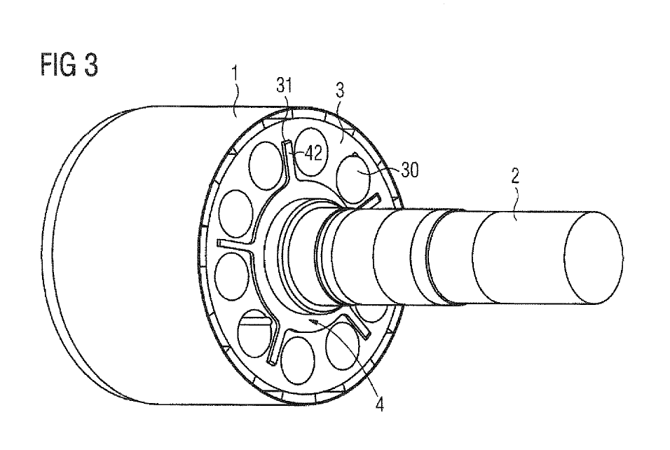

Turning now to the drawing, and in particular to FIG. 1, there is shown a perspective view of a rotor having a laminated core 1 which includes a multiplicity of individual laminates arranged axially one behind the other. The rotor laminated core 1 is hereby mounted on a shaft 2. The last individual laminate 3 at an end face of the rotor laminated core 1 is hereby mounted in the same way as all of the other individual laminates, on the shaft without any additional measures for securement in the axial direction and in the circumferential direction. The only attachment for each of the individual laminates 3 is implemented via a force-fitting connection between an internal diameter of each individual laminate 3 and the shaft 2. In order to prevent mechanical stress to bend the last individual laminate 3 at the end surface outwards, the present invention provides a claw-type end plate, generally designated by reference numeral 4, for effecting an additional securement on the terminal end laminate 3 at the end face of the laminated core 1, as will now be described with reference to FIG. 2.

The claw-type end plate 4 is formed from one laminate in the present example, as its name already indicates. The material may be the same as that of the other individual laminates in the rotor laminated core 1. In particular, it may be stamped integrally from one laminate.

The geometry of the claw-type end plate 4 is governed essentially by an annular inner area 40 and a plurality of claws 41 which project radially outward on its external circumference. Each claw 41, which can also be referred to as a projection, has an inner part 42 which is directly adjacent to the annular inner area 40. The annular inner area and the inner parts 42 of the claws 41 therefore extend essentially on one plane. The outer free end 43 of each claw 41 is bent in the present case such that it runs at right angles to the plane, that is to say it points in the axial direction of the annular inner area 40. In this case, all of the outer ends 43 point in the same direction. In the present example, the claw-type end plate 4 has five claws 41, which are distributed uniformally around the external circumference of the annular inner area 40.

FIG. 3 shows how a laminated core arrangement is fixed according to the invention with the aid of a claw-type end plate. In this specific example, the rotor laminated core 1 on the shaft 2 is provided with the claw-type end plate 4 at the end. For this purpose, like the other individual laminates as well, the individual laminate 3 at the end has in addition to normal cutouts 30 specific fixing cutouts 31 or anchoring holes for insertion of the outer ends 43 of the claws 41 of the claw-type end plate 4. Since the claw-type end plate 4 is likewise seated with a force fit on the shaft 2 here (for example by being shrunk on), the claw-type end plate 4 provides additional axial fixing as well as additional fixing in the circumferential direction for the last individual laminate 3.

As can be seen from the example in FIG. 2, it is advantageous for the outermost projected ends 43 of the claws 41 to extend in the axial direction over a length which is a multiple of the laminate thickness of one individual laminate and of the claw-type end plate 4. In consequence, in the fitted state, the claw-type end plate 4 engages into corresponding fixing cutouts in a plurality of individual laminates. If the fixing cutouts 31 are of an appropriate size, the ends 43 of the claws 41 can therefore produce an interlock with a plurality of rotor laminates. Since an assembly such as this requires a considerably greater torque to twist it, this reduces the risk of twisting of the last rotor laminates.

During assembly, the rotor laminated core 1 is fitted together with the claw-type end plate 4 as a laminated core arrangement to the shaft 2. The rotor laminate fixing (claw-type end plate 4) is therefore fitted to the shaft 2 at the same time as the rotor laminated core 1. The claw-type end plate therefore prevents the outer, end individual laminate and possibly also the individual laminates located underneath it from being bent during the assembly process itself.

One particular advantage of the claw-type end plate 4 is, however, that assembly time can be saved. This is because the laminated core 1 can be fitted to the shaft 2 together with the claw-type end plate 4 in a single process, as a result of which the rotor laminates are fixed (in general the outermost end laminate or laminates is or are fixed) at the same time that the laminated core is fitted.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A laminated core arrangement for an electrical machine, comprising:
a laminated core including individual laminates along a rotation axis of the electrical machine and having a plurality of cutouts which extend along the rotation axis; and
a claw-type end plate arranged on one end face of the laminated core and having an annular inner area provided with projections configured in the form of claws and extending outward in the form of a star, each said projection having an inner part which points radially outward, and an outer free end which points into a respective one of the cutouts in the laminated core.

2. The laminated core arrangement of claim 1, wherein the claw-type end plate is shaped to seat in the cutouts in the laminated core in at least one of an interlocking engagement and force-fitting engagement with respect to an axial movement.

3. The laminated core arrangement of claim 1, wherein the claw-type end plate is shaped to seat in the cutouts in the laminated core in at least one of an interlocking engagement and force-fitting engagement with respect to a movement in a circumferential direction.

4. The laminated core arrangement of claim 1, wherein the free end of the projection extends through a plurality of individual laminates in an axial direction.

5. The laminated core arrangement of claim 1, constructed in the form of a rotor and mounted on a shaft.

6. The laminated core arrangement of claim 5, wherein the annular inner area is mounted on the shaft with an interference fit.

7. The laminated core arrangement of claim 1, wherein the free end extends at a right angle to the projection.

8. An electric motor, comprising a rotor defined by a rotation axis and having a laminated core which is comprised of individual laminates along the rotation axis and has a plurality of cutouts which extend along the rotation axis, and a claw-type end plate arranged on one end face of the laminated core and having an annular inner area provided with projections configured in the form of claws and extending outward in the form of a star, each said projection having an inner part which points radially outward, and an outer free end which points into a respective one of the cutouts in the laminated core.

9. The electric motor of claim 8, wherein the claw-type end plate is shaped to seat in the cutouts in the laminated core in at least one of an interlocking engagement and force-fitting engagement with respect to an axial movement.

10. The electric motor of claim 8, wherein the claw-type end plate is shaped to seat in the cutouts in the laminated core in at least one of an interlocking engagement and force-fitting engagement with respect to a movement in a circumferential direction.

11. The electric motor of claim 8, wherein the free end of the projection extends through a plurality of individual laminates in an axial direction.

12. The electric motor of claim 8, further comprising a shaft, said rotor being mounted on the shaft.

13. The electric motor of claim 12, wherein the annular inner area is mounted on the shaft with an interference fit.

14. A method of making a laminated core, comprising the steps of:
stacking a plurality of laminates, thereby defining an outermost laminate; and
placing a claw-type end plate onto the outermost laminate to secure the outermost laminate in place.

15. The method of claim 14, wherein the placing step includes the step of inserting an outer free end of the claw-type end plate in aligned anchoring holes of the outermost laminate and further laminates arranged axially behind the outermost laminate and behind one another.
